(19) United States
(12) Patent Application Publication
(10) Pub. No.: US 2016/0271498 A1
(43) Pub. Date: Sep. 22, 2016

(54) SYSTEM AND METHOD FOR MODIFYING HUMAN BEHAVIOR THROUGH USE OF GAMING APPLICATIONS

(71) Applicants: Miles Queller Lifton, Boca Raton, FL (US); Gary Bruce Lifton, Boca Raton, FL (US); Danielle Queller Lifton, Boca Raton, FL (US)

(72) Inventors: Miles Queller Lifton, Boca Raton, FL (US); Gary Bruce Lifton, Boca Raton, FL (US); Danielle Queller Lifton, Boca Raton, FL (US)

(21) Appl. No.: 15/075,340

(22) Filed: Mar. 21, 2016

Related U.S. Application Data
(60) Provisional application No. 62/136,154, filed on Mar. 20, 2015.

(51) Int. Cl. A63F 13/67; A63F 13/212

(52) U.S. Cl. CPC A63F 13/67; A63F 13/212

(57) ABSTRACT

A gaming system for training to modify behavior includes a trainer database for storing data input by a trainer that documents behavioral data corresponding to a player and is collected or observed by the trainer when the player is not playing a game offered through use of a gaming engine; a player device used by the player to play a game selected from a gaming database, used to generate player behavioral data uploaded to the gaming database and based on the player's interactions with the game, and used to interact with the trainer through the gaming engine; and an I/O device in communication with the player device or the gaming engine for collecting location or vitals data corresponding to the player as the player plays the game. Game settings can be changed based on the player's interactions with the game or based on the location or vitals data.

### CROSS REFERENCE TO RELATED APPLICATIONS

This application claims the benefit of U.S. Provisional Patent Application Ser. No. 62/136,154, filed Mar. 20, 2015, the entire contents of which are herein incorporated by reference.

### FIELD OF THE DISCLOSURE

The present invention relates to the field of applications for portable multifunction devices such as tablets or smart phones. More specifically, the invention relates to the use of portable multifunction devices for implementing games that may be used to alter human behavior and calculate behavioral metrics.

### BACKGROUND

In modern times, when children have easy access to streaming media, parents sometimes may lose track of all of the information to which a child is exposed, which may result in undesired behavior. Even when a child is not exposed to multimedia that may have an undesired impact on the child's behavior, a child will unavoidably interact with other children that may have picked up bad habits through exposure to streaming media or otherwise resulting from lack of parental supervision.

While schools offer a number of resources to assist with a child's behavioral development, such resources are no replacement for proper parental supervision. In order to assist parents and teachers in reshaping undesirable behavior in children, such as bullying, lack of patience, lack of motivation, etc., there is a need in the art for technical tools to assist with improving child development, for example, through gaming. There is also a need in the art for technical tools that enable behavioral re-training in general.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate the scope of the system and method disclosed herein. Its sole purpose is to present some concepts of the disclosure in a simplified form as a prelude to the more detailed description that is presented later.

A gaming system for training to modify behavior includes a trainer database for storing data input by a trainer that documents behavioral data corresponding to a player and is collected or observed by the trainer when the player is not playing a game offered through use of a gaming engine; a player device used by the player to play a game selected from a gaming database, used to generate player behavioral data uploaded to the gaming database and based on the player's interactions with the game, and used to interact with the trainer through the gaming engine; and an I/O device in communication with the player device or the gaming engine for collecting location or vitals data corresponding to the player as the player plays the game. Game settings can be changed based on the player's interactions with the game or based on the location or vitals data.

The following description and the annexed drawings set forth in detail certain illustrative aspects of the disclosure. These aspects are indicative, however, of but a few of the various ways in which the principles of the system and method disclosed herein may be employed and the system and method disclosed herein is intended to include all such aspects and their equivalents. Other advantages and novel features of the system and method disclosed herein will become apparent from the following detailed description of the system and method disclosed herein when considered in conjunction with the drawings.

### BRIEF DESCRIPTION OF THE DRAWINGS

The accompanying drawings, which are incorporated in and constitute a part of this specification, show certain aspects of the present invention and, together with the description, help explain some of the principles associated with the invention.

FIG. 1 is a block diagram illustrating an exemplary portable multifunction device with a touch-sensitive display in accordance with some embodiments of the present invention.

FIG. 2 illustrates a computer game system architecture in accordance with one embodiment.

FIG. 3 illustrates a cyberglove for use with the system illustrated in FIG. 2 in accordance with one embodiment.

### DETAILED DESCRIPTION OF THE DISCLOSURE

Reference will now be made in detail to embodiments, examples of which are illustrated in the accompanying drawings. The following description refers to the accompanying drawings, in which, in the absence of a contrary representation, the same numbers in different drawings represent similar elements. The implementations set forth in the following description do not represent all implementations consistent with the claimed invention. Instead, they are merely some examples of systems and methods consistent with certain aspects related to the invention. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense.

As used herein, an element or step recited in the singular and proceeded with the word “a” or “an” should be understood as not excluding plural of said elements or steps, unless such exclusion is explicitly stated. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Embodiments of applications executed by portable multifunction devices, user interfaces for such devices, and associated processes for using such devices are described. In some embodiments, the device is a portable communications device such as a mobile telephone that also contains other functions, such as PDA and/or music player functions. The device may also be a tablet, smart phone, or the like.

For simplicity, in the discussion that follows, a prior art portable multifunction device that includes a touch screen is used as an exemplary embodiment for executing the applications of the present invention. A prior art portable multifunction device such as an iPhone™ or the device disclosed in U.S. Pat. No. 7,479,949 can be used to execute the applications of the present invention. The applications can also be executed in portable multifunction devices that do not include a touch screen for inputting information, but that rely instead on a more conventional mechanism, for example point-and-click, keypad, keyboard, or click-wheel mechanisms.

In addition to supporting the applications of the present invention, the portable multifunction device described below can support a variety of applications, such as one or more of the following: a telephone application, a video conferencing application, an e-mail application, an instant messaging application, a blogging application, a photo management application, a digital camera application, a digital video camera application, a web browsing application, a digital music player application, and/or a digital video player application.

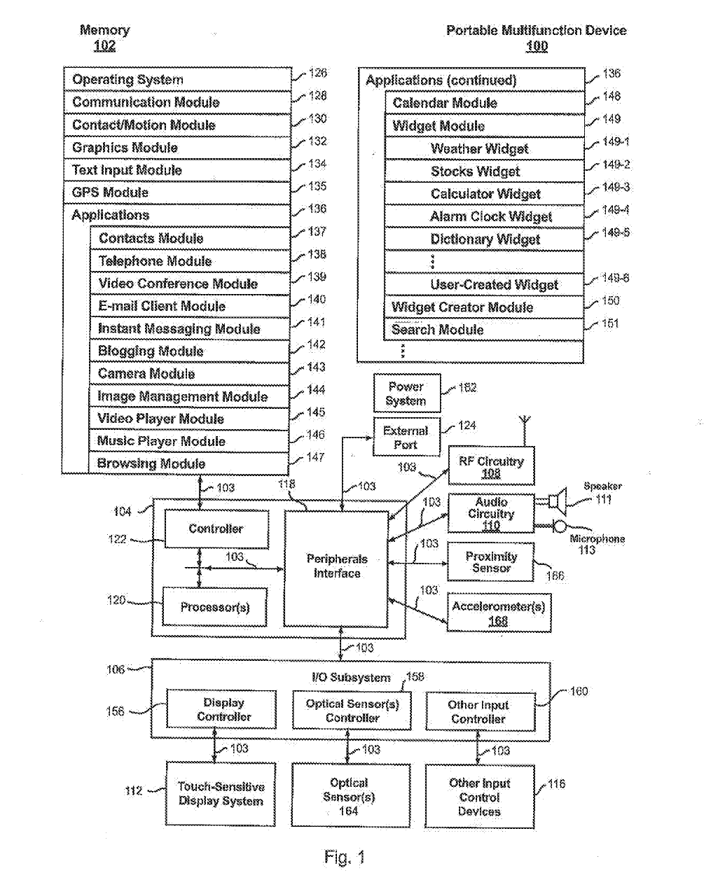

FIG. 1 is a block diagram illustrating an exemplary prior art portable multifunction device 100 with a touch-sensitive display 112 modified to include the applications of the present invention. The touch-sensitive display 112 is also known in the art as a touch screen or a touch-sensitive display system. The device 100 may include a memory 102 (which may include one or more computer readable storage mediums, including a tangible non-transitory computer readable medium or media), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

The device 100 is only one example of a portable multifunction device 100 that may be used to execute the applications of the present invention, and that the device 100 may have more or fewer components than shown, may combine two or more components, or a may have a different configuration or arrangement of the components. The various components shown in FIG. 1 may be implemented in hardware, software or a combination of both hardware and software, including one or more digital signal processing (“DSP”) circuits and/or application specific integrated circuits (“ASICs”).

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device 100 to the CPU 120 and memory 102. The one or more processors 120 run or execute various software programs and/or sets of instructions stored in memory 102 to perform various functions for the device 100 and to process data.

The peripherals interface 118, the CPU 120, and the memory controller 122 may be implemented on a single chip, such as a chip 104. They may also be implemented on separate chips.

The transceiver circuitry 108 receives and sends electromagnetic signals. A person of ordinary skill in the art would recognize that these signals are conventionally referred to as radio frequency (“RF”) signals in the context of portable devices, regardless of whether the signals fall within what is conventionally known as the radio spectrum. The term transceiver circuitry and RF circuitry will be used interchangeably in the present application.

The RF circuitry 108 converts electrical signals to/from electromagnetic signals and communicates information to and from communications networks and other communications devices by modulating/demodulating electromagnetic signals with data corresponding to the information. The RF circuitry 108 may include circuitry known in the art for performing these functions, including but not limited to an antenna system, one or more amplifiers, filters, a tuner, one or more oscillators, a digital signal processor, a CODEC chipset, modulator/demodulator, a subscriber identity module (SIM) card, memory, and so forth. The RF circuitry 108 may communicate with networks, such as the Internet, an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this application.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. The audio circuitry 110 may also include a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. Input controller(s) 160 may also be coupled to any (or none) of the following: a keyboard, infrared port, USB port, and a pointer device such as a mouse.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”).

A touch screen 112 has a touch-sensitive surface, sensor or set of sensors that accepts input from the user through tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. For example, a point of contact between a touch screen 112 and the user corresponds to a finger of the user.

The touch screen 112 may use LCD (liquid crystal display) technology, or LPD (light emitting polymer display) technology, although other display technologies may also be used. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIG. 1 shows an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. The optical sensor may be located on the back of the device 100, opposite the touch screen display 112 on the front of the device, so that the touch screen display may be used as a viewfinder for either still and/or video image acquisition. An optical sensor may also be located on the front of the device so that the user's image may be obtained for videoconferencing while the user views the other video conference participants on the touch screen display. Preferably, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIG. 1 shows a proximity sensor 166 coupled to the peripherals interface 118. Alternately, the proximity sensor 166 may be coupled to an input controller 160 in the I/O subsystem 106. The proximity sensor 166 may be used to turn off and disable the touch screen 112 when the multifunction device is placed near the user's ear (e.g., when the user is making a phone call). The proximity sensor can also be used to keep the screen off when the device is in the user's pocket, purse, or other dark area to prevent unnecessary battery drainage when the device is a locked state.

The device 100 may also include one or more accelerometers 168. FIG. 1 shows an accelerometer 168 coupled to the peripherals interface 118. Alternately, the accelerometer 168 may be coupled to an input controller 160 in the I/O subsystem 106. The accelerometer 168 captures data that is analyzed to determine whether to change a view of information, for example from portrait to landscape, displayed on the screen of the portable device.

The software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). Alternatively the contact/motion module 130 and the controller 160 detect contact on a click wheel, for example.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications modules 136 may include the following modules (or sets of instructions), or a subset or superset thereof: a contacts module 137 (sometimes called an address book or contact list); a telephone module 138; a video conferencing module 139; an e-mail client module 140; an instant messaging (IM) module 141; a blogging module 142; a camera module 143 for still and/or video images; an image management module 144; a video player module 145; a music player module 146; a browser module 147; a calendar module 148; widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; search module 151; video and music player module, which merges video player module 145 and music player module 146; notes module; and/or map module; and/or online video module.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it easy to create and send e-mails with still or video images taken with camera module 143.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages.

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files.

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). A widget may include an HTML (Hypertext Markup Language) file, a CSS (Cascading Style Sheets) file, and a JavaScript file. A widget may also include an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module may be used to create and manage notes, to do lists, and the like.

In conjunction with RF circuitry 108, touch screen 112, display system controller 156, contact module 130, graphics module 132, text input module 134, GPS module 135, and browser module 147, the map module may be used to receive, display, modify, and store maps and data associated with maps (e.g., driving directions; data on stores and other points of interest at or near a particular location; and other location-based data).

In conjunction with touch screen 112, display system controller 156, contact module 130, graphics module 132, audio circuitry 110, speaker 111, RF circuitry 108, text input module 134, e-mail client module 140, and browser module 147, the online video module allows the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In other modes of operation, instant messaging module 141, rather than e-mail client module 140, is used to send a link to a particular online video.

In one embodiment, each of the above identified modules and applications correspond to a set of instructions for performing one or more functions described above. These modules (e.g., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module). Memory 102 may store a subset of the modules and data structures identified above. Furthermore, memory 102 may store additional modules and data structures not described above.

The device 100 may be a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

In other embodiments, a computer may be used to run the gaming applications and the metrics calculations of the present disclosure. The various embodiments and/or components, for example, the modules, elements, or components and controllers therein, may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), field-programmable gate arrays (FPGAs), graphical processing units (GPUs), logic circuits, and any other circuit or processor capable of executing the functions described herein. The above examples are exemplary only, and are thus not intended to limit in any way the definition and/or meaning of the term “computer.”

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software”, “firmware” and “algorithm” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

The present disclosure addresses the need for behavior training and/or therapy related to behavior and emotional issues (e.g., phobias), particularly for children. While the use of games to treat behavioral training for children has been suggested, known games have been limited to the use of rigid games (i.e. games that do not have a set of rules or features that change over time to tailor the changing needs of a particular child) and/or video games that are bought off the shelf and that provide no ability for a parent or supervisor to change the game's settings, features, themes, etc., in accordance with improved (or non-improved) behavior. Likewise, there is no disclosure in the prior art regarding changing these settings, configurations, or themes by a parent or supervisor based on behavior metrics.

In accordance with one aspect of the present invention, a downloadable software application may be installed in a tablet, smart phone, or personal computer to be used by a child. Alternatively, a group of children may access the application to participate in a group therapy session. The application may include a library of video games, each of which may address a particular need of the child. The two-sided parent guided behavioral modification application can be remotely adjusted so that the games can be modified (theme, setting, configuration, introduction of new characters, etc.) by a parent or supervisor. The level of modification of the video game settings will be tailored by needs of the child using the application and playing the video games as those needs change. That is, the games may be customized based on behavioral feedback and the child's progress or lack thereof.

In one embodiment, the library of games available through the software application will include independent games each of which may be used by a parent or supervisor to address at least one of the exemplary behavioral characteristics listed below:
Bullying
Self care
Shyness
Compassion
Greed
Sharing
Patience

Alternatively, the library of games available through the software application will include interdependent games, each of which may be used by a parent or supervisor to address two or more of the behavioral characteristics listed above.

In one embodiment, the menu of games will be able to be built specifically to each child so they are not distracted by extra games that are not specific to them, and can be “hidden” from view on the child's side.

One aspect of the present invention includes the collection of data that tracks the performance of the child as he or she plays a particular game and correlating that data with behavioral metrics collected outside of the realm of the video game (for example, through teacher evaluation of behavior, etc.). Depending on an analysis of that correlation, a parent or supervisor may adjust the game parameters to condition the child's behavior. Behavior may be monitored and tracked through progress reports to the teacher, parent, or other administrator of the application who is monitoring the child's progress. In some embodiments, multiple administrators (such as a teacher and a parent) may simultaneously monitor and administrator the application through a network. Such a network may include multiple computers or mobile devices, one for each administrator. Administrators may also manually input their observations into the application. For instance, if a teacher is observing that “bullying” characteristics of a child are improving, than a teacher may manually input his or her observations and thereby adjust the child's progress in the game. Similarly, if a child is not progressing as he or she would be expected to in the real world, one or more administrators may manually adjust the game's settings even though the child seemed to be progressing as measured by performance within the game. In this regard, while the application may automatically analyze the progress of a child's behavior adjustment, such as through statistical regression models tracking data associated with the child's performance within a game or series of games, the progress of the child's behavior adjustment outside the context of the gaming platform may be manually adjusted as necessary based on real-world observation of the child.

In one embodiment, multiple accounts may be linked so that the application can be used in a true group setting. For example, in a group setting session, two children with different behavioral training needs may face different challenges (as potentially configured by their respective parents) as they jointly play a game from the library of games available through the application.

In one embodiment, a game to address “greediness” issues may be deployed as part of the software application. As a child plays the game, the child will have the option of obtaining rewards for one of his friends in real life upon reaching certain milestones (e.g., completing a first stage of a role playing game, completing a puzzle, etc.). As the game progresses, the child can obtain rewards for both himself and his friend(s) as additional milestones are reached. These rewards may be redeemable for tangible items at virtual or brick and mortar retails stores, such as candy from a candy store or toys from a toy store. In another embodiment, the rewards may be virtual with non cash value such as emblems, virtual trophies, etc.

In one embodiment, a game to address “patience” issues may be deployed as part of the software application. The game for patience may include special exploding, floating dots that may be in a different size or color to distinguish them from ordinary dots that do not provide a reward or other positive feedback. Children will know that a special floating dot of the right size or shape sends off fireworks (or it can be programmed to explode flowers, teddy bears, etc.) when it is touched. Children will anticipate the appearance of such a floating dot, and look and wait for it. The time interval between each special dot arriving and the explosion time can be changeable. After long periods of game play, over time, the goal is for a young child to patiently wait for the reward of the fireworks for possibly a minute—or longer—after pressing the special dot.

In another embodiment, the game may address “self care” and the child may earn rewards tied to improved grooming, such as grooming products or discounts for grooming services. The rewards can be pre-selected to promote a certain kind of behavior. Alternatively, for self-care, a game can display an animal care game, where (virtual) pets are brought into a pet shop—bunnies, kittens, puppies, monkeys, unicorns, etc. Children may earn points for checking on and caring for the animals before sending them to another virtual location (such as a farm, home, hibernation cave, clouds, etc.) appropriate for the type of animal in question. For example, the child playing the game would need to make sure that the animal's teeth are brushed, its hair is washed and combed, its nails are filed and possibly painted, it has had perfume (deodorant) applied, its clothes have been selected and donned, etc. before the animal may be dispatched to its destination. A checklist may also be available and printable for kids to use in real life. Also, children can customize the look of the virtual animals (eyes, fur, etc.) and indicate places for the animals to go to.

The types of games may be selectively designed such that the child, or other subject of the application, is unaware of the behavior modification nature of the game. For instance, while a child plays a game designed to correct bullying, and is rewarded for anti-bullying behavior while playing the game, the theme, setting, and gameplay may be disguised such that it is not overtly clear to the child that his or her behavior is being modified. Games may be pre-programmed with set levels for the child to experience. Additionally, or alternatively, the administrators may be able to modify or design levels of their own based on the behavior to be modified and based at least in part on the individual child's characteristics.

In another embodiment, a game to address extreme shyness in a child may be deployed as part of the software application. The game may begin with a maze challenge where the character controlled by the child does not interact with any other human-like character. Rewards may be given when the character controlled by the child interacts with any other human like characters, including teaming up to face particular challenges and even allowing the character controlled by the child to ask or enter questions for the other human-like characters. Rewards could be tied to a couple of gifts (pair of movie tickets so that child can interact with a single other person in real life when child is extremely shy) and may include discounts for a venue to hold a birthday party when child has progressed and is no longer as shy.

In another aspect of the present invention, the software application may be run in a virtual reality setting so that the child can play video games in a 360 degree virtual reality environment.

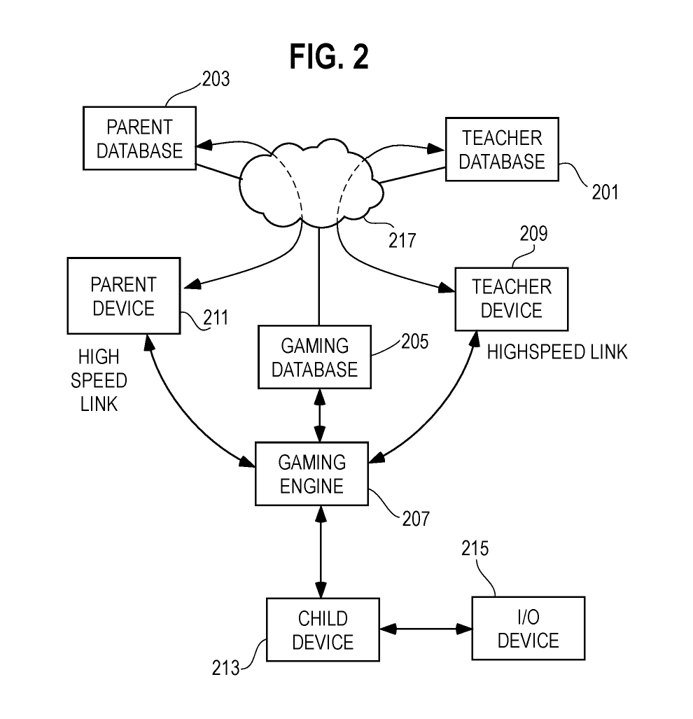

FIG. 2 illustrates one implementation of an architecture that may be used to practice the system of the present disclosure. The system may include a teacher database 201, a parent database 203, a gaming database 205, a gaming engine 207, a teacher device 209, a parent device 211 and a child/player device 213. Children/player devices may be connected to I/O devices 215, for example a cyberglove with sensors.

A teacher database 201 may be defined as a database that contains data input by teachers that document behavioral data collected or observed by teachers in a classroom, for example, with respect to a child or children. It will be appreciated that the term “teacher” in this context is not intended to be limited to an academic instructor, but rather is intended to be read broadly to include any guardian, babysitter, authority figure, therapist, or other trainer engaged in the process of monitoring and modifying the behavior of a child. The data may include an identification of a child behavioral pattern such as a phobia, bullying, shyness, etc. The data may also include more specific behavioral data such as the historical behavior or any indications of improvement, stagnation, or regression with respect to a particular behavior of a child. The parent database 203 may include similar data and may be defined as a database that contains data input by parents that document behavioral data collected or observed by parents outside of a classroom, for example, with respect to a child or children. The parent database 203 may be accessed by a parent device 211 through a WAN 217, for example. Similarly, the teacher database 201 may be accessed by a teacher device 209 through WAN 217, for example. It is noted that WAN 217 is representative only, and may be embodied in or comprise any suitable networking hardware and technologies; the present invention is not intended to be limited by any particular network configuration or industry protocols implemented by or in association with WAN 217.

The gaming database 205 may be defined as a database that collects data obtained from a child's interactions with the gaming engine 207, including decision making by children as they play a game run by gaming engine 207, stress level experienced, reaction times to stimuli, and other input provided by children as they play a game run by the gaming engine 207, etc. As noted above, the gaming database 205 may also store a library of games.

The gaming engine 207 may be defined as a gaming console, server, or the like which is accessible by teacher devices 209, parent devices 211 and children devices 213 through high speed communication links, for example, and which may run behavioral computer games uploaded from the gaming database 205. The gaming engine 207 may include a high performance DSP gaming processor such as would be recognized by persons skilled in the art. The gaming engine 207 may also download data from the parent database 203 or the teacher database 201 in order to set gaming parameters in accordance with predetermined or dynamically adjusted rules. For example, if a behavior data from a parent database 203 and a teacher database 201 identify particular phobia or behavioral characteristic for a child that needs to be improved, the gaming engine 207 may offer as part of a game menu a game that will be offered to the child and which will help with the behavioral issue that needs improvement. In one embodiment, some of the functionalities of the gaming engine 207 may be locally run in the teacher devices 209, parent devices 211 or children devices 213. The gaming engine 207 may change game settings on the fly based on predetermined rules based on a child's progress in a game or based on other feedback obtained from a child's sensed physiological conditions (e.g., fast heartbeat, etc.) in order to modify behavioral training. Alternatively, the game settings may be changed by a parent or teacher on the fly based on observed behavior of a child by monitoring the child's progress while playing a game or a child's interactions with the gaming engine. The gaming engine 207 may include a monitor and other I/O interfaces to interact with the devices 213, 211, and 209 or to allow reprogramming of settings. In some implementations, gaming engine 207 may be embedded in or integrated with child device 213; for instance, it may be desirable to implement gaming engine 207 as an application module 136 or as an integrated hardware element or processing unit 120 residing on device 100 as set forth above with reference to FIG. 1. Alternatively, gaming engine 207 may be implemented remotely from child device 213, as noted above; in such an embodiment, gaming engine 207 may reside on a desktop computer, gaming console, or a remote server as set forth above, or it may be implemented as a stand-alone device.

In one embodiment, the gaming engine 207 may implement an augmented reality (“AR”) gaming application. For example, learning to set the table using an AR game (at a first level) would allow for setting a real table with placement shown through the AR viewer by shape of fork, spoon, etc. At the second level the exact shape could be altered so the child knows one of the utensils goes in a specific spot but has to remember where from prior gaming which one it was.

A teacher device 209 may be defined as a computer, smart phone, tablet, game controller or any other similar computing device that may be used by a teacher to upload child behavioral data to the teacher database 201, or to interact with the gaming engine 207, for example, by participating in a game with a child (for example, without revealing the teacher's identify to the child). The teacher's device 209 may also interact with the gaming engine 207 through a high speed link to change a game's settings offline or while the game is being played by the child in real time.

A parent device 211 may be defined as a computer, smart phone, tablet, game controller or any other similar computing device that may be used by a parent to upload child behavioral data to the parent database 203, or to interact with the gaming engine 207, for example, by participating in a game with a child (for example, without revealing the parent's identify to the child). The parent's device 211 may also interact with the gaming engine 207 through a high speed link to change a game's setting offline or while the game is being played by the child in real time. The parent device 211 may also be used to change access settings in the gaming engine 207 to control access or control of gaming settings and who can interact with a child during a gaming session.

A child device 213 may be defined as a computer, smart phone, tablet, game controller or any other similar computing device that may be used by a child to generate child behavioral data which can then be uploaded to the gaming database 205, or to interact with parents or teachers through the gaming engine 207, for example. In accordance with one embodiment, the gaming engine 207 can be adjusted on the fly based on collected data from the child. For example, if a child is being treated for a phobia, the pace of the game may be adjusted based on the child's heartbeat or other vitals data collected, for example, by a cyberglove worn by a child and connected to the child device (wirelessly or through a wired connection). As set forth above, it may be desirable in some instances to integrate gaming engine 207 with child device 213, though FIG. 2 illustrates these as discrete entities.

The child device 213 may also connect with a number of I/O devices 215 that can be used to collect or sense behavioral data in real-time, including movement, heartbeat, and other vitals. This data may ultimately be relayed to the gaming database 205 in order to modify game settings, difficulty levels, or other parameters in accordance with a proper desired training. Additionally or alternatively, the I/O device 215 may communicate directly with the gaming engine 207.

In one embodiment, the I/O device may be implemented as a toy that can interact directly with the gaming engine 207 or with the child device 213. The toy may be implemented as a toy for children or for pets when the system is being used to train pets.

In another embodiment, the I/O includes a camera but the recorded video may or may not be displayed to the child. For example, in one embodiment a first I/O device is a camera and a second I/O device may be implemented as a hairbrush that counts strokes or a toothbrush that charts teeth brushing and measures time used, for example. The child may earn a reward based on number of strokes recorded by the brush (which may include a built in counter). The child may be aware of how close he or she is to earning the reward. In another embodiment the parents can track the child's progress without the child knowing that the parents are tracking the progress.

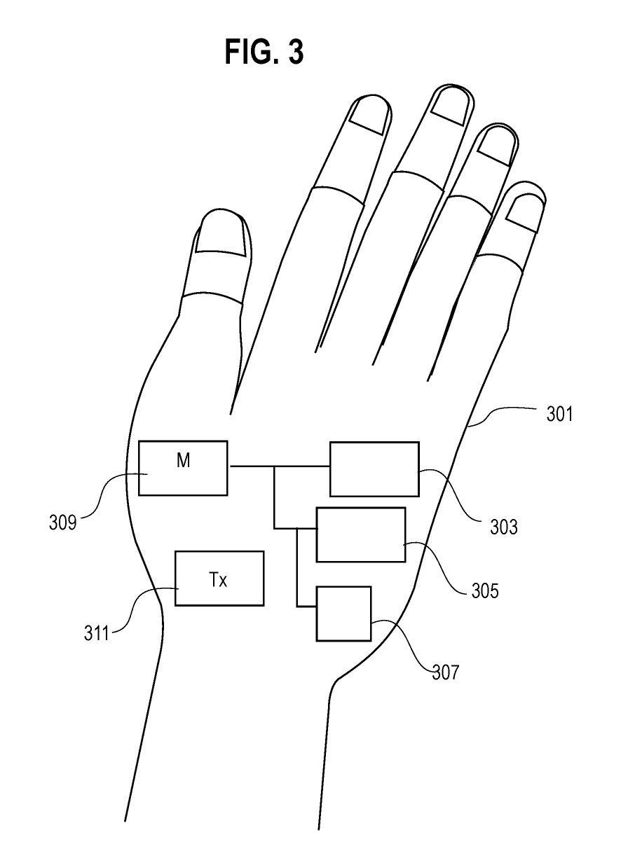

Referring to FIG. 3, in one embodiment the I/O device 215 may include a cyberglove 301 that can be used to monitor movement (such as with accelerometers, piezoelectric materials, and other sensing technologies) with use of a sensor 303 during a gaming or training session related to grooming. Alternatively, the cyberglove 301 may also include an electrodermal activity (EDA) sensor 305, a pulse oximeter 307, or other sensors to detect a child's vitals during a gaming session and adjust the gaming settings on the fly in accordance with a proper training protocol. The cyberglove 301 may include openings so that the player's fingertips are exposed in order to enable the player to use the finger tips and better interact with the child's device 213. For example when treating a phobia, the pace of a game may slow down when a rapid heartbeat is detected as a child plays a game or the gaming engine 207 may switch to another type of game.

The cyberglove 301 may also include a processor 309 that processes data acquired by sensors 303, 305 and 307 and which may also control a transceiver 311 in order to communicate the data to the child device 213. Functionally associated with processor 309 is the EDA sensor 305, in accordance with one embodiment. EDA sensor 305 may be mounted on glove 301 such that a sensing portion of the sensor is in direct contact with the child/player's skin. The sensed signal may be processed by the sensor or by processor 309, either individually or in cooperation. The EDA sensor may be configured to measure the child's skin conductance and to provide an EDA signal indicating the measured skin conductance to the processor 309 at a sensing rate.

Functionally associated with processor 309 is a pulse oximeter 307, in accordance with one embodiment. Pulse oximeter 307 may be mounted on glove 301 such that a sensing portion, which may include a light source and a photodetector, is in direct contact with the child's skin, and the signal sensed by the oximeter 307 may be processed by the meter 307 or by the processor 309, or by both. In some embodiments, the pulse oximeter is enclosed in a protective enclosure (not shown), such as a silicon cushion to prevent sweat buildup on the pulse oximeter 307. The pulse oximeter 307 may be configured to measure the child's pulse and blood oxygenation percentage and to provide a pulse oximeter signal indicating at least one of, the measured pulse and blood oxygenation percentage to the processor 309. Similar sensors may be deployed on utensils or other I/O devices to be used depending on the gaming application. U.S. Pat. No. 8,368,641 and U.S. Patent Pub. No. 2015/0201846, which are herein incorporated by reference in their entireties, disclose sensors and sensor interfaces (including processors, transceivers and software applications) that may be used with the system and method of the present disclosure.

The use of the present invention is not limited to children. The present invention can be used for occupational therapy, and thus Adults using the gaming application can also benefit from the use of the invention. Thus, the present invention can also be used for general medical monitoring, vocational training, military training, governmental use, and general educational use, and machine training (i.e., machines playing video games). Animals, such as pets requiring behavioral adjustment, may also be the subject of the behavior adjusting games described herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112(F), unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

1. A gaming system for enabling training to modify behavior comprising:
a trainer database for storing data input by a trainer through a trainer device that documents behavioral data corresponding to a player and is collected or observed by said trainer when the player is not playing a game offered through use of a gaming engine;
a player device used by said player to play a game selected from a gaming database, used to generate player behavioral data based on the player's interactions with the game, and used to interact with the trainer through a gaming engine;
and an I/O device in communication with the player device or the gaming engine for collecting location or vitals data corresponding to the player as the player plays the game;
wherein the gaming database stores data collected from said player's interactions with the game while playing the game, stores said location or vitals data corresponding to the player, and stores a library of games that enable training to modify of behavioral patterns, said library including said game;
wherein the gaming engine is in communication with the player device and runs the game; and
wherein game settings can be changed on the fly based on the player's interactions with the game or based on said location or vitals data.

2. The gaming system of claim 1, wherein said gaming engine downloads data from the trainer database to set gaming parameters in accordance with predetermined rules.

3. The gaming system of claim 2, wherein said game settings can be changed by said trainer on the fly based on the player's interactions with the game or based on said location or vitals data.

4. The system of claim 1, wherein the I/O device is a cyberglove.

5. The system of claim 4, wherein the cyberglove includes a transceiver and at least one of
a movement sensor for determining the position of the cyberglove by the gaming engine;
an EDA sensor; and
a pulse oximeter.

6. The system of claim 5, wherein any of the outputs of the movement sensor, EDA sensor or pulse oximeter is transmitted to the gaming engine to determine a stress level experienced by a player.

7. The system of claim 6, wherein the stress level is used by the gaming engine to alter gaming parameters and modify player behavior.

8. The system of claim 1, wherein the data stored in the trainer database includes an identification of a player's behavioral pattern including at least one of a phobia, bullying, or shyness.

9. The system of claim 1, wherein the data stored in the trainer database includes the historical player behavioral data or any indications of improvement, stagnation, or regression with respect to a particular behavior of a player.

10. The system of claim 1, wherein said game settings can be changed by said trainer in order to modify the game's theme and to introduce characters.

11. The system of claim 1, wherein said game settings can be changed by said trainer in order to provide an option for the player to obtain rewards for reaching a game milestone.

12. The system of claim 1, wherein said game settings can be changed by said trainer to address a behavioral pattern associated with the player's lack of patience; wherein the game includes a sequence that causes the display of exploding, floating dots in a different size or color and which send off fireworks when touched, with the time interval between each dot arriving and the fireworks time being adjustable; causing the player to wait for a reward associated with a firework after touching the special dot in accordance with said time.

13. The system of claim 1, wherein said game settings can be changed by said trainer to address a behavioral pattern associated with the player's lack of self care or grooming; wherein the game allows issuance of rewards related to grooming products or discounts for grooming services

14. The system of claim 13, wherein the rewards are pre-selected to promote improved grooming behavior.
